(19) United States
(12) Patent Application Publication
(10) Pub. No.: US 2011/0240763 A1
(43) Pub. Date: Oct. 6, 2011

(54) FLUID CONTAINER CONNECTION MECHANISM

(75) Inventors: John M. Svendsen, Corcoran, MN (US); Jeffrey M. Smith, Elko New Market, MN (US)

(73) Assignee: Wagner Spray Tech Corporation, Plymouth, MN (US)

(21) Appl. No.: 12/754,217

(22) Filed: Apr. 5, 2010

(51) Int. Cl. B05B 9/043; B05B 7/24; B23P 11/00

(52) U.S. Cl. 239/332; 239/333; 222/383.1; 222/575; 29/428

(57) ABSTRACT

The present disclosure generally relates to a spray gun for spraying fluid materials such as paints, stains, and the like, and more specifically, but not by limitation, to a fluid container connection for a spray gun. In one example, a sprayer is provided and includes a housing and a fluid container cover attached to the housing. The fluid container cover is configured to be removably coupled to a fluid container. The fluid container cover comprises a portion having a first side facing the fluid container and second side facing a direction generally opposite the first side. At least one orifice is formed through the portion between the first side and the second side. The fluid container includes at least one connection mechanism configured to be received by the at least one orifice and engage the second side of the portion of the fluid container cover.

### BACKGROUND

The present disclosure generally relates to mechanisms for connecting fluid containers in a fluid delivery system or device and more specifically, but not by limitation, to a fluid container connection mechanism for a portable spray gun.

Fluid delivery systems and devices, such as, but not limited to, paint spraying systems and devices, include a fluid container that holds fluid material (e.g., paint, stain, varnish, texture material, and the like) to be sprayed. For example, spray guns used in spray-coating systems often utilize a container that is removably connected to the spray gun. The container is removable for filling, cleaning, etc.

The discussion above is merely provided for general background information and is not intended to be used as an aid in determining the scope of the claimed subject matter.

### SUMMARY

In one exemplary embodiment, a sprayer is provided and includes a fluid container cover configured to be removably coupled to a fluid container. The fluid container cover comprises a portion having a first side facing the fluid container and a second side facing a direction generally opposite the first side. At least one orifice is formed through the portion between the first side and the second side. The fluid container includes at least one connection mechanism configured to be received by the at least one orifice and engage the second side of the portion of the fluid container cover.

In one exemplary embodiment, a fluid container configured for use with a fluid sprayer is provided. The fluid container includes a body forming an interior compartment configured to hold fluid material. The body includes a top surface configured to engage a portion of a fluid sprayer for securing the fluid container to the fluid sprayer. The fluid container also includes a plurality of connection mechanisms spaced about and extending from the top surface. Each of the plurality of connection mechanisms includes a portion extending in a direction along the top surface, the portion of the connection mechanism being spaced apart from the top surface and configured to receiving a portion of the fluid sprayer therebetween.

In one exemplary embodiment, a method of connecting a fluid container to a sprayer is provided. The method includes inserting a plurality of connection mechanisms on the fluid container through a plurality of corresponding apertures formed in a fluid container cover of the sprayer. The fluid container cover comprises a portion having a first side facing a body of the fluid container and a second side facing a direction generally opposite the first side. The method also includes rotating the fluid container with respect to the fluid container cover such that the plurality of connection mechanisms engage the second side of the fluid container cover.

These and various other features and advantages will be apparent from a reading of the following Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a perspective view of a spray gun, under one embodiment.

FIG. 2 is a perspective view of a fluid container, under one embodiment.

FIG. 3 is a perspective view of the fluid container shown in FIG. 2, illustrating the fluid container removed from a fluid container cover.

FIG. 4 is a top view of a fluid container, under one embodiment.

FIG. 5 is a bottom view of a fluid container cover, under one embodiment.

FIG. 6 is a side view of a fluid container including an enlarged view of a connection mechanism, under one embodiment.

FIG. 7 is a perspective view of a fluid container, under one embodiment.

### DETAILED DESCRIPTION

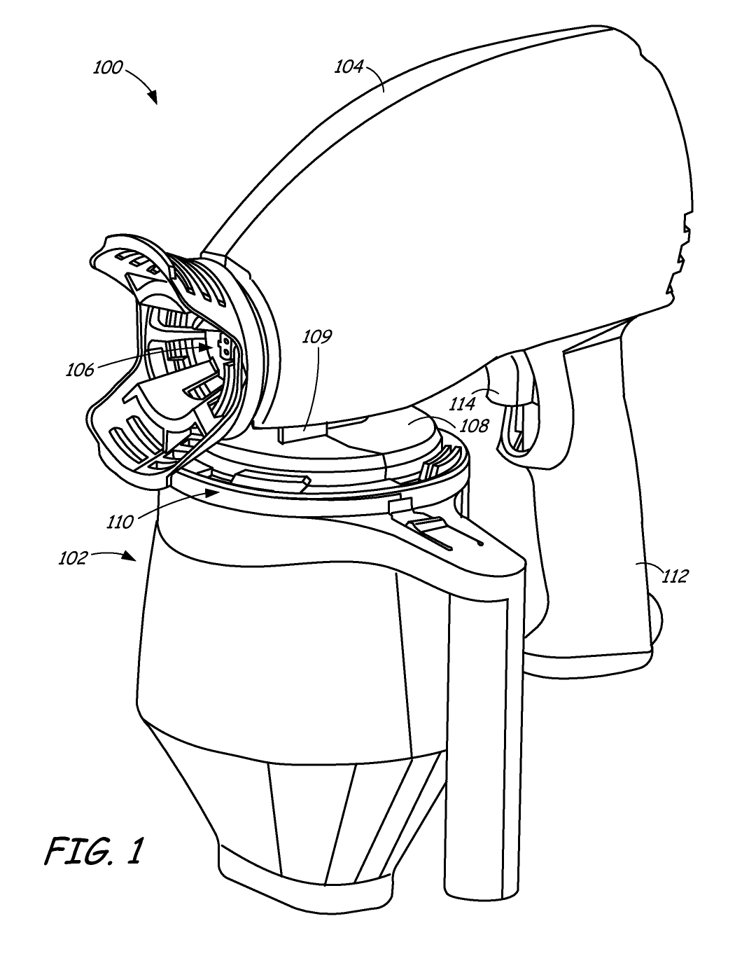

FIG. 1 illustrates a portable sprayer 100 configured to spray a fluid material (e.g., paints, varnishes, stains, inks, etc.) through the air onto a surface. In the embodiment illustrated in FIG. 1, sprayer 100 comprises a handheld spray gun; however, sprayer 100 can be utilized to deliver other types of material. Spray gun 100 illustratively comprises an airless system and uses a pumping unit for pumping the paint material from a paint source, illustratively a fluid container 102.

Spray gun 100 includes a housing 104 containing electrical components for controlling operation of spray gun 100 and an electric drive or motor operably coupled to drive a pump mechanism. The pump mechanism supplies paint from container 102 to an output nozzle 106 having a particular size and shape for generating a desired spray pattern. A suction tube assembly (not shown in FIG. 1) is positioned within container 102 and supplies a fluid path from the container 102. In one embodiment, a suction tube extends into housing 104 and/or is attached to a portion of a fluid container cover 108. In the illustrated embodiment, cover 108 includes and/or is attached to a stem 109 that extends into housing 104. Stem 109 is supported by housing 104 and/or motor/pump assembly disposed within housing 104.

Spray gun 100 also includes a handle 112 and a trigger 114 that allow a user to hold and control the operation of spray gun 100. A power source (not shown in FIG. 1) supplies power to the electric drive or motor in housing 102. For example, the power source can comprise a power cord connected to an AC power source, such as a wall outlet. In another example, the power source can comprise a battery pack. An exemplary battery pack can include primary (e.g., non-rechargeable) batteries and/or secondary (e.g., rechargeable) batteries. The battery pack can be mounted to spray gun 100 (for example, to handle 112) or can be external and connected to spray gun 100 through a power cord.

Container 102 is removably connected to cover 108 using a connection mechanism (generally illustrated by reference numeral 110), thereby allowing container 102 to be removed for filling, cleaning, etc. In one example, container 102 can be removed from cover 108 and reattached in different orientations, for example for spraying at different angles. In another example, container 102 can be replaced with a container having a different size, shape, etc.

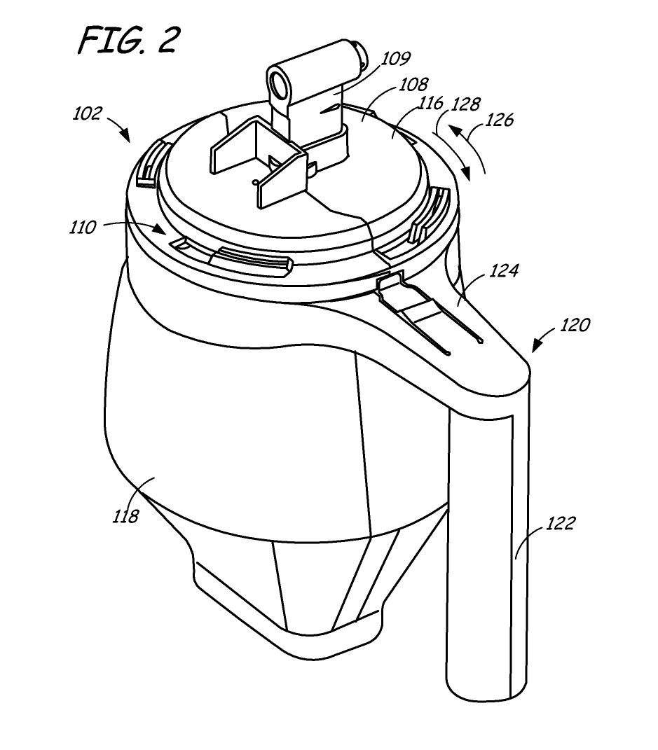

FIG. 2 is a perspective view illustrating container 102 and container cover 108. As shown, container cover 108 includes stem 109 that extends from a top surface 116 of cover 108 and is configured to be received within housing 104 (shown in FIG. 1) of spray gun 100.

Fluid container 102 includes a container body 118 forming an interior compartment for holding fluid material. Fluid container 102 also includes a handle 120 extending from body 118. Handle 120 can comprise a separate piece attached to body 118 or can be integral, formed of a single unitary body. In the illustrated embodiment, handle 120 comprises a grip portion 122 attached to body 118 by an arm portion 124. In the illustrated embodiment, grip portion 122 is substantially vertical and is configured to be gripped in a user's hand.

Connection mechanism 110 is configured to connect and disconnect container 102 from cover 108 through rotation of container 102 with respect to cover 108. By way of example, container 102 is rotated in a direction illustrated by arrow 126 to engage and secure connection mechanism 110 and in a direction illustrated by arrow 128 to disengage connection mechanism 110. Connection mechanism 110 is configured to enable connection of container 102 to cover 108 by rotating container 102 less than a full turn (i.e., less than 360 degrees, less than 180 degrees, less than 90 degrees, etc.). In one embodiment, container 102 is connected or disconnected from cover 108 by rotating container 102 approximately 20 degrees.

Connection mechanism 110 provides a connection for container 102 that is easy to use, secure, and durable (i.e., resistant to breakage if dropped), in contrast to conventional connection structures which can be awkward and cumbersome to use, and may not provide adequate sealing capabilities or durability.

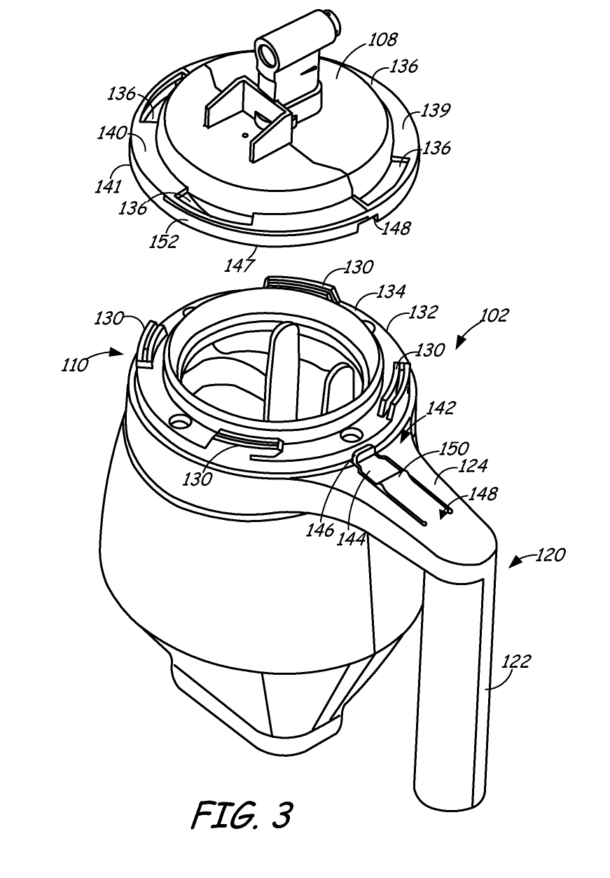

As illustrated in FIG. 3, connection mechanism 110 comprises a plurality of connection components 130 that are spaced about and extend from a top surface 132 of a portion of container 102. Top surface 132 engages a bottom surface of container cover 108. In the illustrated embodiment, connection mechanism 110 comprises four connection components 130 that are substantially equally spaced along a perimeter 134 of surface 132. For example, components 130 are spaced at approximately 90 degrees increments about the perimeter 134. However, it is noted that more than or less than four components 130 can be utilized.

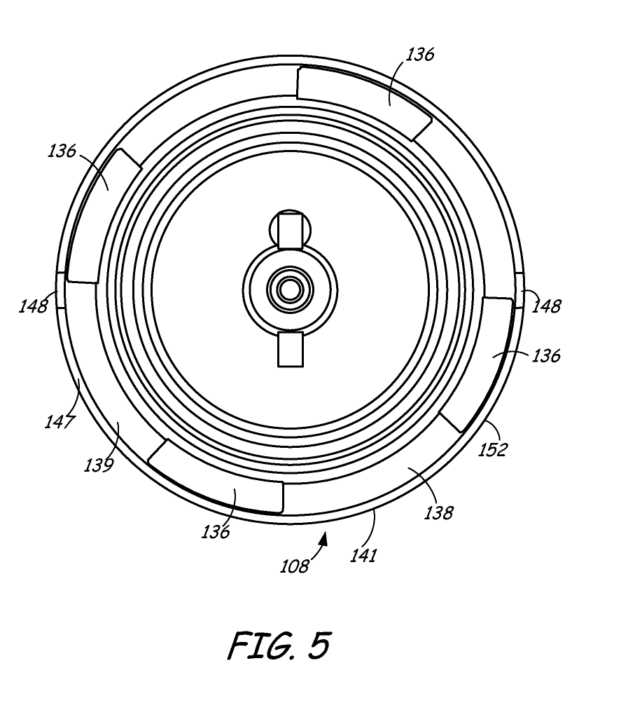

Cover 108 comprises a plurality of orifices 136 configured to be aligned with components 130. Each orifice 136 comprises an opening or aperture through a portion 139 of cover 108 and is configured to receive one of the plurality of connection components 130. As illustrated, portion 139 is proximate the perimeter 141 of cover 108 and each orifice 136 is formed between a bottom surface 138 (illustrated in FIG. 5) and a top surface 140 of portion 139. To attach container 102 to cover 108, connection components 130 are inserted through orifices 136 and container 102 is rotated with respect to cover 108 such that the connection components 130 move with respect to and engage the top surface 140 of portion 139.

In the illustrated embodiment, container 102 also includes a locking mechanism 142 that is configured to engage cover 108 and prevent or limit rotation of container 102 with respect to cover 108. Locking mechanism 142 comprises a tab 144 having a portion 146 that extends upwardly toward and is configured to engage a corresponding notch 148 formed in cover 108. Tab 144 is biased toward a neutral, locked (positions), (which is shown in FIG. 3). Tab 144 is depressible in a downward direction to an unlocked position in which portion 146 disengages notch 148. In one embodiment, tab 144 is formed integral with arm portion 124 of handle 120. A portion (generally represented by reference numeral 148) comprises a resilient, flexible material. In another embodiment, tab 144 can be connected to arm portion 124 by a hinged joint, for example. Tab 144 can be biased to the locked position shown in FIG. 3 by a spring, for example.

During connection of container 102 to cover 108, tab 144 is depressed by a bottom surface 147 (shown in FIGS. 3 and 5) of cover 108. As container 102 is then rotated with respect to cover 108, tab 144 moves toward and engages notch 148. Tab 144 returns to its neutral, undepressed state wherein portion 146 of tab 144 is received within notch 148. In this manner, a user is not required to manually depress tab 144 during connection of container 102.

To remove container 102 from cover 108, a user depresses tab 144 to disengage portion 146 from notch 148, thereby allowing container 102 to be rotated with respect to cover 108. In one embodiment, tab 144 can include a protrusion 150 that aids a user in depressing tab 144. In one embodiment, tab 144 is positioned along arm portion 124 of handle 120 such that tab 144 is easily reachable by a user's thumb when grip portion 122 is grasped in the user's hand.

In one embodiment, cover 108 can include a plurality of notches 148. Container 102 can be connected to cover 108 in different orientations. For example, container 102 can be rotated 90 degrees, 180 degrees, 270 degrees, etc. with respect to cover 108. Each connection component 130 can be received by any one of the plurality of orifices 136. In the embodiment illustrated in FIG. 5, cover 108 comprises two notches 148 formed 180 degrees apart along the perimeter 152 of cover 108. However, less than or more than two notches 148 can be utilized.

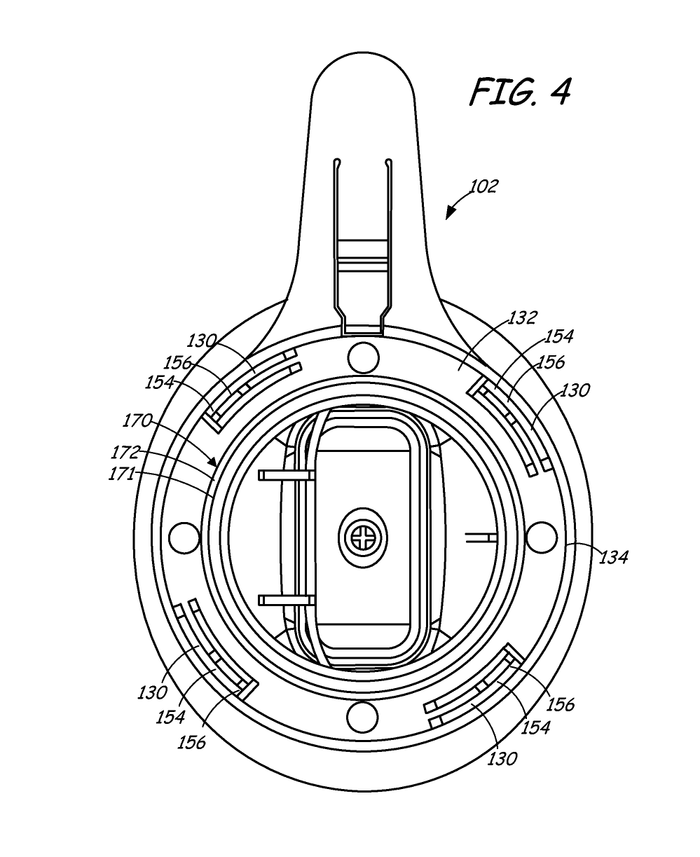

FIG. 4 is a top view of container 102. As shown, connection components 130 are spaced about along the perimeter 134 of the top surface 132 of container 102. Each of connection components 130 comprises a portion 154 that extends in a direction along a plane of surface 132. In one embodiment, a top surface 156 of portion 154 is substantially parallel to top surface 132 of container 102. Further, the portion 154 of each component 130 can have a curvature that substantially follows a curvature of perimeter 134. As illustrated in FIG. 5, orifices 136 have a similar curvature to accommodate components 130.

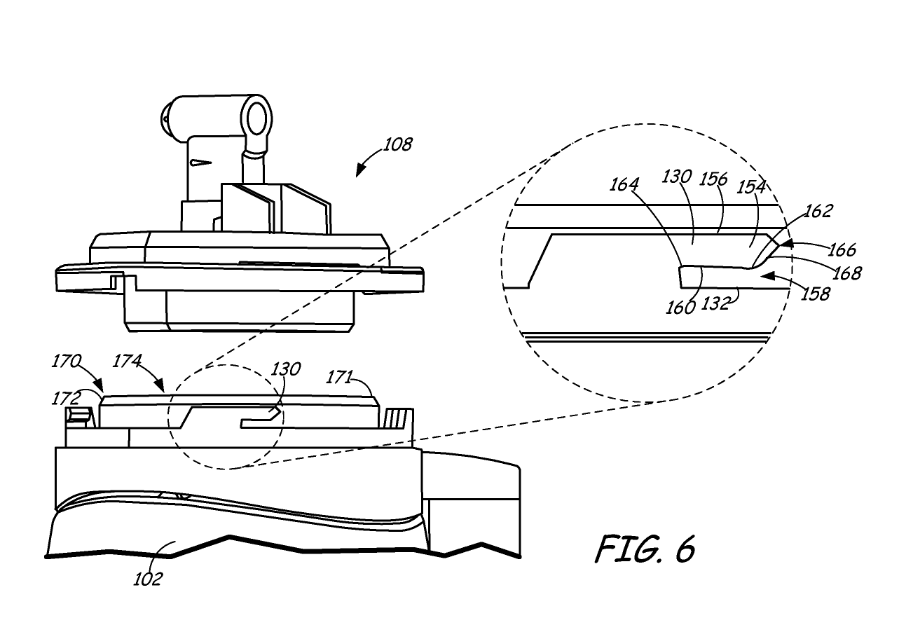

FIG. 6 is a side view of container 102 illustrating an exemplary connection component 130 in an enlarged view. As shown in FIG. 6, the top surface 156 is substantially planer and parallel to the surface 132 of container 102. A gap 158 is formed between portion 154 and surface 132. The gap 158 is configured to receive a portion of cover 108 therein. In one example, gap 158 is sized such that portion 154 applies a force against cover 108 to retain the portion of cover 108 within gap 158. In the illustrated example, a bottom surface 160 of portion 154 is angled such that gap 158 has a smaller cross-section at a first end 162 as opposed to a second end 164.

In one embodiment, an end 166 of connection 130 comprises an angled surface 168 to aid in the insertion of cover 108 into gap 158. By way of example, the cross-section of gap 158 at end 162 is smaller than the thickness of the portion of cover 108 to be received within gap 158. As container 102 is rotated with respect to cover 108, a portion of cover 108 contacts surface 168 causing mechanism 130 to deform to some extent and receive the portion of cover 108 within gap 158.

As illustrated in FIG. 6, container 102 also includes a pour spout 170 (also shown in FIG. 4) configured to improve the flow of material poured from container 102. For example, pour spout 170 can be formed by an angled surface 172, formed around the opening 174 of container 102. In this manner, a tip or top surface 171 (see also FIG. 4) of spout 170 has a reduced thickness or cross-section. Pour spout 170 is advantageous in that it can provide improved pouring capabilities when emptying the contents of container 102, for example.

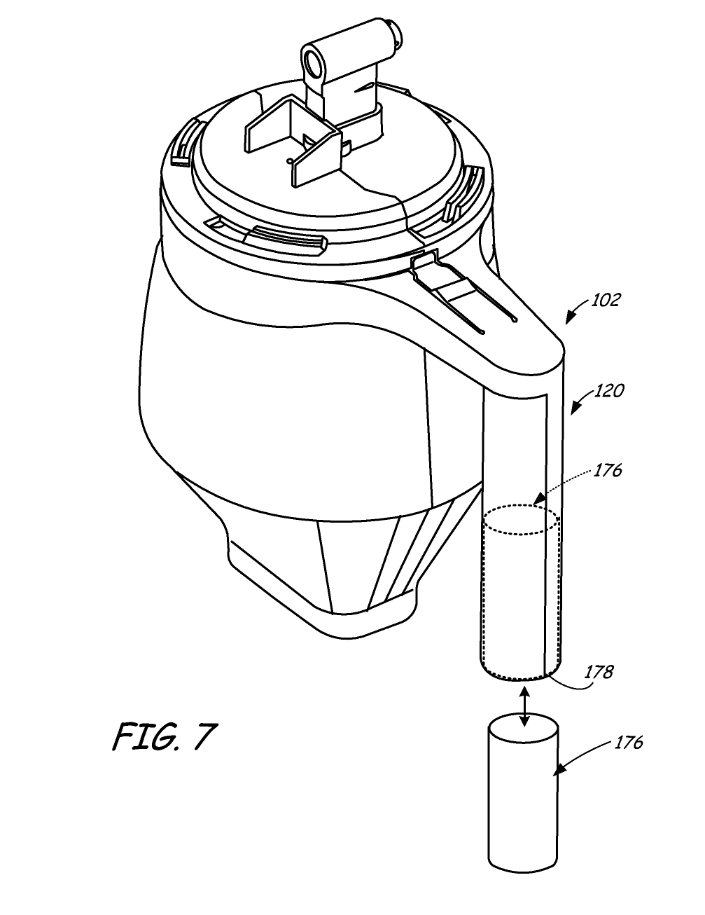

FIG. 7 is a perspective view of one embodiment of fluid container 102 having a compartment formed in handle 120 for removably retaining a tool or implement 176 therein. By way of example example, implement 176 comprises a cleaning kit and/or spare parts for spray gun 100. In one embodiment, implement 176 is friction fit within handle 120. In another embodiment, handle 120 can include a cap or plug that retains implement 176 within the compartment formed in handle 120. In one embodiment, implement 176 and the interior compartment of handle 120 are sized such that at least a portion of implement 176 extends beyond the end 178 of handle 120 when implement 176 is inserted into handle 120.

While various embodiments of the invention have been set forth in the foregoing description, together with details of the structure and function of various embodiments of the disclosure, this disclosure is illustrative only, and changes may be made in detail, especially in matters of structure and arrangement of parts within the principles of the present disclosure to the full extent indicated by the broad general meaning of the terms in which the appended claims are expressed. For example, the particular elements may vary depending on the particular application for the system or method while maintaining substantially the same functionality without departing from the scope and spirit of the present disclosure and/or the appended claims.

What is claimed:

1. A fluid sprayer comprising:
a fluid container; and
a fluid container cover configured to be removably coupled to the fluid container, wherein the fluid container cover comprises a portion having a first side facing the fluid container and second side facing a direction generally opposite the first side, wherein at least one orifice is formed through the portion between the first side and the second side; and
wherein the fluid container includes at least one connection mechanism configured to be received by the at least one orifice and engage the second side of the portion of the fluid container cover.

2. The sprayer of claim 1, and further comprising a main body that houses a pump mechanism, wherein the fluid container cover includes a stem extending into the main body, and wherein the second side of the fluid container cover faces the housing.

3. The sprayer of claim 2, wherein the stem provides a fluid path therethrough from the fluid container to the main body.

4. The sprayer of claim 1, wherein the at least one connection mechanism comprises a plurality of connection mechanisms that are spaced apart and extend from a top surface of the fluid container, the top surface comprising a surface that faces the fluid container cover.

5. The sprayer of claim 4, wherein each of the plurality of connection mechanisms includes a portion extending in a direction that is substantially parallel to the top surface, the portion of the connection mechanism being spaced apart from the top surface to form a gap therebetween.

6. The sprayer of claim 5, wherein the gap is configured to receive a portion of the fluid container cover.

7. The sprayer of claim 5, wherein the at least one orifice comprises a plurality of orifices, each of the plurality of orifices being configured to receive one of the plurality of connection mechanisms, each of the plurality of orifices being sized to receive the portion of the connection mechanism extending in the direction that is substantially parallel to the top surface.

8. The sprayer of claim 1, wherein the fluid container comprises a lock mechanism configured to engage a portion of the fluid container cover.

9. The sprayer of claim 8, wherein the lock mechanism comprises a tab having a portion that extends toward and is received by a notch formed in the first side of the fluid container cover.

10. The sprayer of claim 9, wherein at least a portion of the tab is formed of a resilient material such that the tab is depressible by a user to disengage the lock mechanism.

11. A fluid container configured for use with a fluid sprayer, the fluid container comprising:
a body forming an interior compartment configured to hold fluid material, wherein the body includes a top surface configured to engage a portion of a fluid sprayer for securing the fluid container to the fluid sprayer; and
a plurality of connection mechanisms spaced about and extending from the top surface, wherein each of the plurality of connection mechanisms includes a portion extending in a direction along the top surface, the portion of the connection mechanism being spaced apart from the top surface and configured to receiving a portion of the fluid sprayer therebetween.

12. The fluid container of claim 11, wherein the portion of each connection mechanism has a curvature that substantially follows a curvature of a perimeter of the top surface.

13. The fluid container of claim 11, and further comprises:
a locking mechanism configured to engage a portion of a fluid container cover of the fluid sprayer, wherein the locking mechanism is configured to limit rotation of the fluid container with respect to the fluid container cover.

14. The fluid container of claim 13, wherein the portion of the fluid container cover comprises a notch formed in a surface of the fluid container cover that faces the fluid container.

15. The fluid container of claim 14, wherein the locking mechanism comprises a movable tab having a portion that extends toward and is configured to be received by the notch formed in the surface of the fluid container cover.

16. The fluid container of claim 15, wherein at least portion of the tab is formed of a resilient material such that the tab is depressible by a user to disengage the locking mechanism.

17. A method of connecting a fluid container to a sprayer, the method comprising:
inserting a plurality of connection mechanisms on the fluid container through a plurality of corresponding apertures formed in a fluid container cover of the sprayer, the fluid container cover comprising a portion having a first side facing a body of the fluid container and a second side facing a direction generally opposite the first side; and
rotating the fluid container with respect to the fluid container cover such that the plurality of connection mechanisms engage the second side of the fluid container cover.

18. The method of claim 17, wherein rotating the fluid container comprises rotating the fluid container to engage a fluid container locking mechanism.

19. The method of claim 18, wherein engaging the fluid container locking mechanism comprises rotating the fluid container until a tab of the fluid container engages a notch formed in the first side of the fluid container cover.

20. The method of claim 19, and further comprising disconnecting the fluid container from the sprayer, wherein disconnecting comprises:
depressing the tab to disengage the tab from the notch formed in the first side of the fluid container cover;
rotating the fluid container with respect to the fluid container; and
removing the plurality of connection mechanisms from the corresponding apertures formed in a fluid container cover.
